(19) United States
(12) Patent Application Publication
(10) Pub. No.: US 2014/0293599 A1
(43) Pub. Date: Oct. 2, 2014

(54) AIR COOLING LED LAMP

(71) Applicant: UNILED LIGHTING TW., INC., New Taipei City (TW)

(72) Inventors: Ming-Te LIN, New Taipei City (TW); Ming-Yao LIN, New Taipei City (TW); Heng QIU, Kaohsiung (TW)

(73) Assignee: UniLED Lighting TW., Inc., New Taipei City (TW)

(21) Appl. No.: 13/853,647

(22) Filed: Mar. 29, 2013

(51) Int. Cl. F21V 29/00

(52) U.S. Cl. CPC F21V 29/004
USPC 362/235

(57) ABSTRACT

An air cooling LED lamp is disclosed. The lamp has air passages for natural air flow for cooling the lamp without using any electric fan to reduce electric energy consumption. The air passages still work for natural air cooling for the lamp when the lamp is configured either in a top down position or in a lateral position.

### BACKGROUND

1. Technical Field

The present invention relates to a lamp, especially an air cooling LED lamp which has air passages for natural cooling the lamp without using an electric fan.

2. Description of Related Art

FIG. 1 is a prior art

FIG. 1 shows a prior art, it discloses an LED lamp with an electric fan for cooling the lamp. The LED 5 is mounted on a support 4, Cooling air 8 is guided through openings 11 in the lamp base 2 to electric fan 6 and blown out through a cavity 12 of the support 4 upward as discharge stream 9. Cooling fins 13 for reinforced cooling of the support 4 are arranged in cavity 12. By cooling the support 4, the power demand of the LED lamp can be increased.

The deficiency of the prior art is to use an electric an 6 for the cooling. Running of the electric fan 6 consumes electric energy. It is desired to develop a natural cooling system without using an electric fan so as to reduce electricity consumption.

### BRIEF DESCRIPTION OF THE DRAWINGS

FIG. 1 is a prior art

FIG. 2 is a first embodiment according to the present invention

FIG. 3A is a section view of FIG. 2

FIG. 3B is a side view of the light unit of FIG. 3A

FIG. 3C is a front view of the metal strip of FIG. 3B

FIG. 4 is a reversed position of the lamp of FIG. 3A

FIG. 5 is a second embodiment according to the present invention

FIG. 6 is a reversed position of the lamp of FIG. 5

FIG. 7 is a lateral position of the lamp of FIG. 5

FIG. 8 is a modified embodiment according to the present invention

FIG. 9 is a section view of FIG. 8

FIG. 10 is a modified lamp of FIG. 3A

FIG. 11 is a modified light unit of FIG. 3B

FIG. 12 is a further modified light unit of FIG. 3B

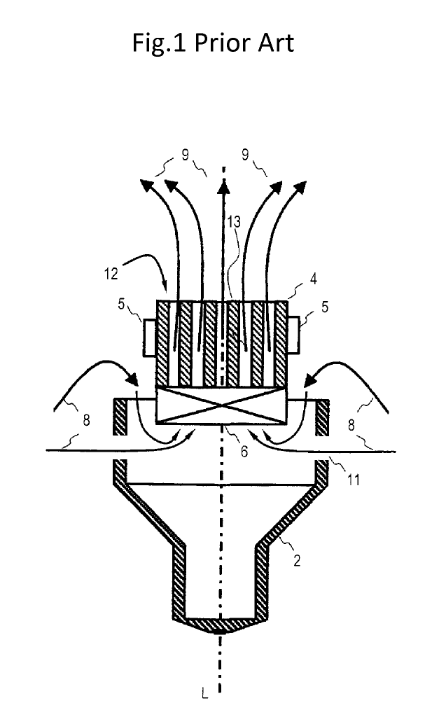

### DETAILED DESCRIPTION OF THE INVENTION

This invention uses air passages for cooling the led lamp without using any electric fan so that the present invention is a green product which reduces electric energy consumption.

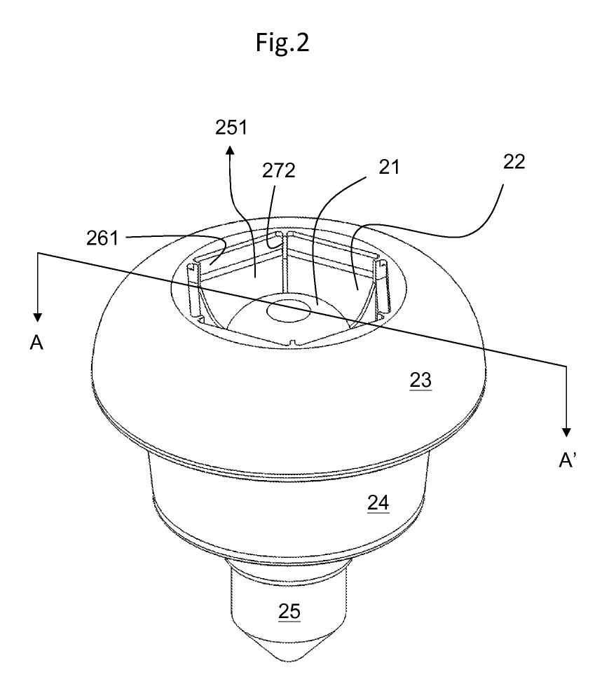

FIG. 2 is a first embodiment according to the present invention

FIG. 2 shows an LED lamp, which has a central tube 21 for housing circuit board and other electronic elements. A circular light wall 22 encloses the central tube 21. An air passage 251 is formed between the central 21 and the light wall 22 for a natural air-flow bottom up. A lamp base 25 is configured on a bottom of the central tube 21 for being able to mount the lamp to a conventional lamp socket. A top gap 261 is configured on a top of the light wall 22 for air flow. Top rib 272 is used for fixing the position between the light wall and the transparent dome 23. A trumpet cup 24 is configured under the transparent dome 23.

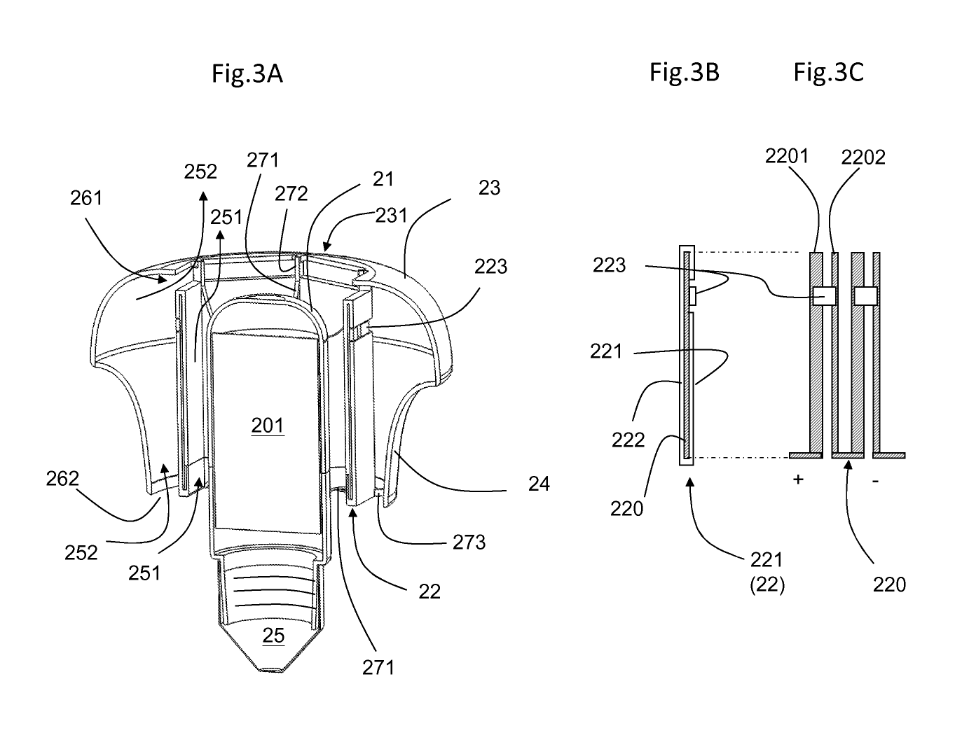

FIG. 3A is a section view of FIG. 2

FIG. 3A is a section view of the lamp according to line AA′ shown in FIG. 2. The section view shows a central tube 21 having circuit board 201 and other electronic elements (not shown) inside. A circular light wall 22 is composed of a plurality of light unit 221 that are configured side by side. The circular light wall 22 surrounds the central tube 21. Each of the light units 221 has a light source 223 mounted on a top end facing outward. A transparent dome 23 surrounds a top of the circular light wall 22 for modifying light beams of the light unit 221 before emitting. A central cavity 231 is configured on a top center of the transparent dome 23.

A first air passage 251 is formed between the central tube 21 and the circular light wall 22 for air flow. A trumpet cup 24 is configured under the transparent dome 23, surrounds lower part of the circular light wall 22. A top gap 261 is configured between a top end of the transparent dome 23 and a top end of the circular light wall 22. The top gap 261 communicates with the central cavity 231. A bottom gap 262 is configured between a bottom of the circular light wall 22 and a bottom of the trumpet cup 24. A second air passage 252 communicates between the top gap 261 and the bottom gap 262 for air flow.

An inner rib 271 is configured between the central tube 21 and the circular light wall 22 for fixing a position between the central tube 21 with reference to the circular light wall 22. An outer rib 273 is configured between the circular light wall 22 and a trumpet cup 24 for fixing a position between the circular light wall 22 and the trumpet cup 24. A top rib 272 is configured between a top end of the circular light wall 22 and a top end of the transparent dome 23 for fixing a position between the circular light wall 22 and the transparent dome 23.

FIG. 3B is a side view of the light unit of FIG. 3A FIG. 3B shows that an LED is mounted on a top of the metal strip 220. A front side protection layer 221 coated on a front side of the metal strip 220 except an area for the LED 223 to mount. Aback side protection layer 222 is coated on a back side of the metal strip 220.

FIG. 3C is a front view of the metal strip of FIG. 3B

FIG. 3C shows the structure of a metal strip 220 of the light unit 221. A pair of metal strips 2201, 2202 is parallel configured. An LED 223 is straddled on a top of the metal strips 2201, 2202.

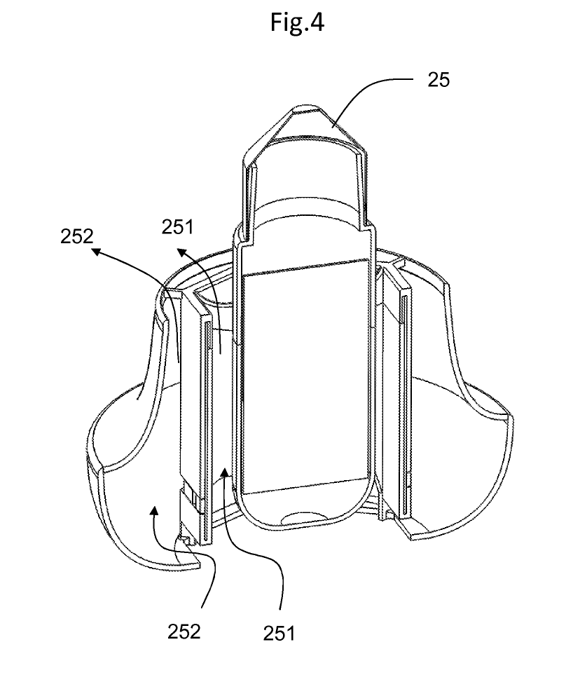

FIG. 4 is a reversed position of the lamp of FIG. 3A

FIG. 4 shows when the lamp of FIG. 3A is configured in a reversed position, the first air passage 251 and the second air passage 252 still work for the air flow cooling bottom up.

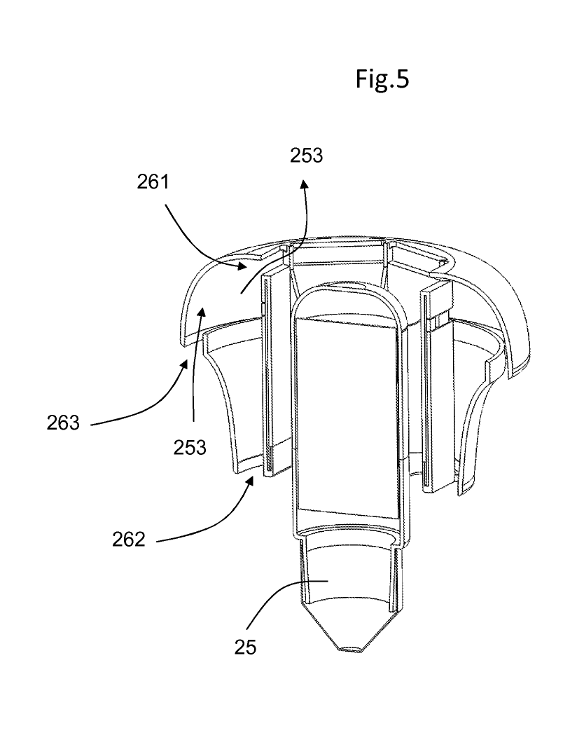

FIG. 5 is a second embodiment according to the present invention

FIG. 5 is a modified lamp of FIG. 3A. FIG. 5 shows that a side gap 263 is configured between a bottom end of the transparent dome 23 and a top end of the trumpet cup 24. A third air passage 253 communicates between the side gap 263 with the top gap 261 for air flow.

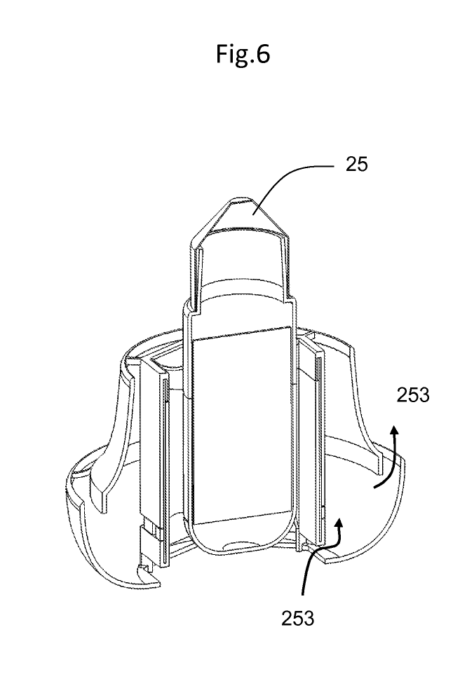

FIG. 6 is a reversed position of the lamp of FIG. 5

FIG. 6 shows when the lamp of FIG. 5 is configured in a reversed position, the third air passage 253 still work for the air flow bottom up.

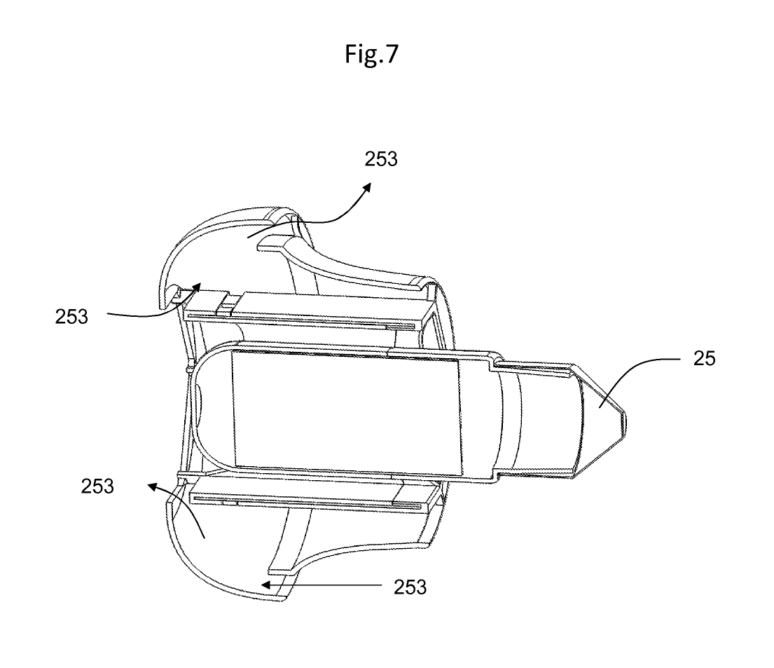

FIG. 7 is a lateral position of the lamp of FIG. 5

FIG. 7 shows when the lamp of FIG. 5 is configured in a lateral position, the third air passage 253 still work for the air flow bottom up.

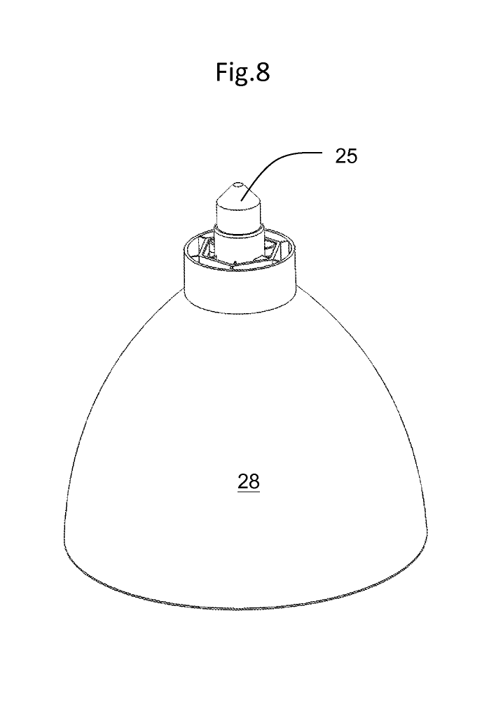

FIG. 8 is a modified embodiment according to the present invention

FIG. 8 shows that a reflection cup 28 is prepared to cover the lamp as a lampshade for modifying the light direction of the light source 223 before emitting.

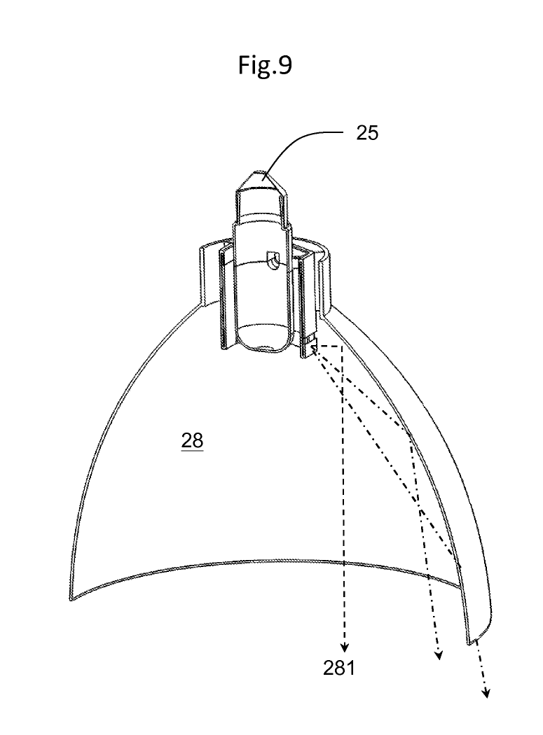

FIG. 9 is a section view of FIG. 8

FIG. 9 shows the direction of the light beams 281 have been modified by the inner wall of the reflection cup 28 before the light beams exiting the lamp.

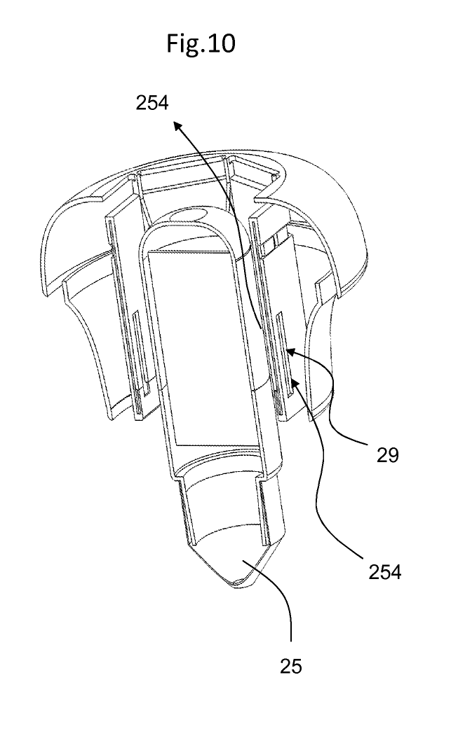

FIG. 10 is a modified lamp of FIG. 3A

FIG. 10 shows that a slot 29 is configured passing through a lower portion of the light unit. A further air passage 254 is formed for air flow to enhance the cooling efficiency.

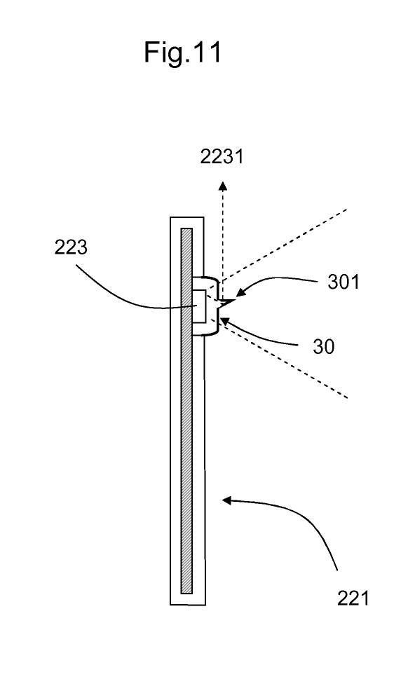

FIG. 11 is a modified light unit of FIG. 3B

FIG. 11 shows that a lens 30 is configured in front of the light source 223 of the light unit 221 for compensating the light beams upward 2231. The lens 30 has a triangle extension 301 for reflecting light beam upward.

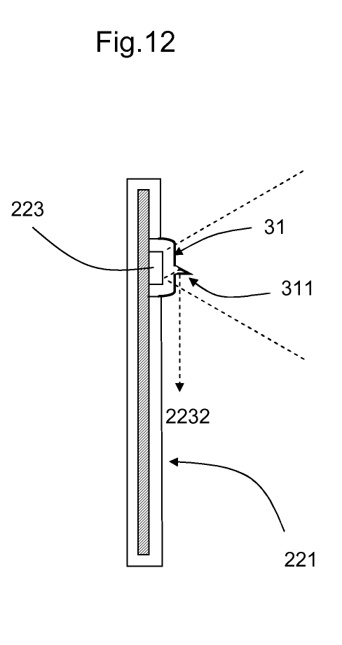

FIG. 12 is a further modified light unit of FIG. 3B

FIG. 12 shows that a lens 31 is configured in front of the light source 223 of the light unit 221 for compensating the light beams downward 2232. The lens has a triangle extension 311 for reflecting light beam downward.

While several embodiments have been described by way of example, it will be apparent to those skilled in the art that various modifications may be configured without departing from the spirit of the present invention. Such modifications are all within the scope of the present invention, as defined by the appended claims.

What is claimed is:

1. An air cooling LED lamp, comprising:
a central tube, having circuit board inside;
a circular light wall, comprising a plurality of light unit configured side by side;
surrounding the central tube; each of the light units having a light source mounted on a top end;
a transparent dome, surrounding a top of the circular light wall for modifying light beams of the light unit before emitting;
a central cavity, configured on a top center of the transparent dome;
a first air passage, configured between the central tube and the circular light wall for air flow.

2. An air cooling LED lamp as claimed in claim 1, further comprising:
a trumpet cup, configured under the transparent dome, surrounding lower part of the circular light wall.

3. An air cooling LED lamp as claimed in claim 2, further comprising:
a top gap, configured between a top end of the transparent dome 23 and a top end of the circular light wall.
a bottom gap, configured between a bottom of the circular light wall and a bottom of the trumpet cup;
a second air passage, communicating between the top gap and the bottom gap for air flow.

4. An air cooling LED lamp as claimed in claim 3,
a side gap, configured between a bottom end of the transparent dome and a top end of the trumpet cup;
a third air passage, communicating between the side gap with the top gap for air flow.

5. An air cooling LED lamp as claimed in claim 1, further comprising:
a protection layer covering front side and back side of the light unit except an area for the light source to mount.

6. An air cooling LED lamp as claimed in claim 1, further comprising:
a reflection cup, surrounding the lamp, for modifying the light direction of the light source before emitting.

7. An air cooling LED lamp as claimed in claim 1, further comprising:
a lamp base, configured on a bottom of the central tube.

8. An air cooling LED lamp as claimed in claim 1, wherein each of the light unit further comprising:
a first metal strip,
a second metal strip, and
a light source, straddled on a top end of the metal strips.

9. An air cooling LED lamp as claimed in claim 8, further comprising:
a front side protection layer, coated on a front side of the metal strip except an area where the light source is mounted.
a back side protection layer, coated on a back side of the metal strip.

10. An air cooling LED lamp as claimed in claim 9, further comprising:
an inner rib, configured between the central tube and the circular light wall.

11. An air cooling LED lamp as claimed in claim 9, further comprising:
an outer rib, configured between the circular light wall and a trumpet cup.

12. An air cooling LED lamp as claimed in claim 9, further comprising:
a top rib, configured between a top end of the circular light wall and a top end of the transparent dome.

13. An air cooling LED lamp as claimed in claim 1, further comprising:
a slot, configured passing through a lower portion of the light unit.

14. An air cooling LED lamp as claimed in claim 1, further comprising:
a lens, configured in front of the light source, having a triangle extension for reflecting light beam upward.

15. An air cooling LED lamp as claimed in claim 1, further comprising:
a lens, configured in front of the light source, having a triangle extension for reflecting light beam downward.
